(19) United States
(12) Patent Application Publication
(10) Pub. No.: US 2020/0055543 A1
(43) Pub. Date: Feb. 20, 2020

(54) MOTOR DRIVE APPARATUS AND ELECTRIC POWER STEERING APPARATUS

(71) Applicant: Nidec Corporation, Kyoto (JP)

(72) Inventors: Tsuyoshi KADOWAKI, Kyoto (JP); Hiroki FUJIWARA, Kyoto (JP)

(21) Appl. No.: 16/607,731

(22) PCT Filed: Apr. 9, 2018
(86) PCT No.: PCT/JP2018/014889

§ 371 Date: Oct. 24, 2019

(30) Foreign Application Priority Data
Apr. 28, 2017 (JP) 2017-090199

(51) Int. Cl. B62D 5/04; B60L 3/00; H02H 7/085

(52) U.S. Cl. CPC B62D 5/0496; B62D 5/0463; H02H 7/0857; B60L 3/0061

(57) ABSTRACT

A motor drive apparatus includes a control assembly that controls driving of a motor. The control assembly includes a controller that outputs a drive signal instructing a drive amount of the motor, a drive that supplies electric current, supplied from an external power supply, to the motor based on the drive signal output from the controller, a current detector that detects electric current flowing through the drive unit, and a first temperature detector that detects temperature of the drive unit. The control assembly calculates a heat storage amount stored in the control assembly at a predetermined cycle, and when the calculated heat storage amount is larger than a predetermined threshold, the control assembly outputs the drive signal that instructs a drive amount smaller than the drive amount at the time of calculation.

### CROSS REFERENCE TO RELATED APPLICATIONS

This is a U.S. national stage of PCT Application No. PCT/JP2018/014889, filed on Apr. 9, 2018, and priority under 35 U.S.C. § 119(a) and 35 U.S.C. § 365(b) is claimed from Japanese Application No. 2017-090199, filed Apr. 28, 2017; the entire contents of each application are hereby incorporated herein by reference.

### 1. FIELD OF THE INVENTION

The present disclosure relates to a motor drive apparatus and an electric power steering apparatus.

### 2. BACKGROUND

Driving of a motor used in an electric power steering apparatus or the like is controlled by a motor drive apparatus having a control unit. Electronic components included in the control unit may be damaged by the heat generated by drive control of the motor. Damage to the electronic components impairs the performance of the electric power steering apparatus.

A conventional overheat protection apparatus calculates an estimated value of the temperature of a motor and a controller without using a temperature sensor and adjusts an electric current supplied to the motor on the basis of the estimated value to thereby prevent overheating of the motor and the motor peripheral device.

However, the conventional overheat protection device does not take into account changes in the heat release amount over time. Therefore, temperature estimation accuracy may be insufficient. When an error in the estimated value becomes larger, for example, an electric current supplied to the motor may be limited in a state where it is not necessary to prevent overheating, and the assisting power of the electric power steering apparatus may be excessively reduced. This may impair driving comfortability.

### SUMMARY

A first example embodiment of the present disclosure is a motor drive apparatus that includes a control assembly that controls driving of a motor. The control assembly includes a controller that outputs a drive signal instructing a drive amount of the motor, a drive that supplies electric current, supplied from an external power supply, to the motor based on the drive signal output from the controller, a current detector that detects electric current flowing through the drive, and a first temperature detector that detects a temperature of the drive. The control assembly calculates a heat storage amount stored in the control assembly at a predetermined cycle, and when the calculated heat storage amount is larger than a predetermined threshold, the control assembly outputs the drive signal that instructs a drive amount smaller than the drive amount at the time of calculation. A heat storage amount Qₙ calculated at the n^{th} time, where n is an integer equal to or greater than 1, by the controller is a value that is obtained by, when Q₀ is a predetermined initial value, adding, to a heat storage amount Qₙ₋₁ calculated at the n−1^{th} time, an estimated value of a heat generation amount of the motor obtained based on a voltage of the external power supply, the predetermined cycle, and a current value of the electric current detected, and subtracting an estimated value of a heat release amount obtained based on a difference between the temperature detected by the first temperature detector and a predetermined temperature.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic diagram of an electric power steering apparatus including a motor drive apparatus according to an example embodiment of the present disclosure.

FIG. 2 is a block diagram showing a configuration of a motor drive apparatus according to an example embodiment of the present disclosure.

FIG. 3A is a diagram showing an arrangement of first temperature detectors according to an example embodiment of the present disclosure when a controller and a drive are on different substrates.

FIG. 3B is a diagram showing an arrangement of first temperature detectors according to an example embodiment of the present disclosure when a controller and a drive are on different substrates, respectively.

FIG. 4A is a diagram showing an arrangement of a second temperature detector when a controller and a drive are on different substrates.

FIG. 4B is a diagram showing an arrangement of a second temperature detector according to an example embodiment of the present disclosure when a controller and a drive are on different substrates.

FIG. 5A is a diagram showing an arrangement of respective temperature detectors according to an example embodiment of the present disclosure when a controller and a drive are on one substrate.

FIG. 5B is a diagram showing an arrangement of respective temperature detectors according to an example embodiment of the present disclosure when the controller and the drive are on one substrate.

FIG. 6 is a block diagram showing respective functions of a controller according to an example embodiment of the present disclosure.

### DETAILED DESCRIPTION

Hereinafter, example embodiments of the present disclosure will be described with reference to the drawings. Note that the scope of the present disclosure is not limited to the example embodiments described below, but includes any modification thereof within the scope of the technical idea of the present disclosure.

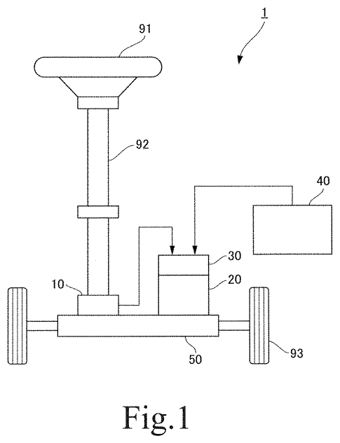

FIG. 1 is a schematic diagram of an electric power steering apparatus 1 including a motor drive apparatus 30 according to the present example embodiment. The electric power steering apparatus 1 is a system that assists a driver's steering wheel operation in a transportation device such as an automobile. As shown in FIG. 1, the electric power steering apparatus 1 of the present example embodiment includes a torque sensor 10, a motor 20, and a motor drive apparatus 30. In the present example embodiment, the motor 20 and the motor drive apparatus 30 are built in a common housing. By making the motor 20 to be in a so-called electromechanical integrated type, for example, the electric power steering apparatus 1 can be reduced in size.

The torque sensor 10 is attached to the steering shaft 92. When the driver operates the steering wheel 91 to rotate the steering shaft 92, the torque sensor 10 detects the torque applied to the steering shaft 92. A torque signal that is a detection signal of the torque sensor 10 is output from the torque sensor 10 to the motor drive apparatus 30. The motor drive apparatus 30 drives the motor 20 on the basis of the torque signal input from the torque sensor 10. The motor drive apparatus 30 may refer to not only the torque signal but also other types of information (for example, vehicle speed).

In the present example embodiment, a three-phase synchronous brushless motor is used as the motor 20. The motor 20 is configured of a three-phase coil of a U phase, a V phase and a W phase. When the motor 20 is driven, electric current is supplied from the motor drive apparatus 30 to each of the U phase, the V phase, and the W phase in the motor 20. When the electric current is supplied, a rotating magnetic field is generated between a stator having a three-phase coil of the U phase, the V phase and the W phase and a rotor having a magnet. As a result, the rotor rotates with respect to the stator of the motor 20.

The motor drive apparatus 30 supplies a driving current to the motor 20 using electric power obtained from the external power supply 40. The driving force generated from the motor 20 is transmitted to the wheels 93 via a gear box 50. Thereby, the steering angle of the wheel 93 changes. Thus, the electric power steering apparatus 1 amplifies the torque of the steering shaft 92 by the motor 20, and changes the steering angle of the wheel 93. Therefore, the driver can operate the steering wheel 91 with a light force.

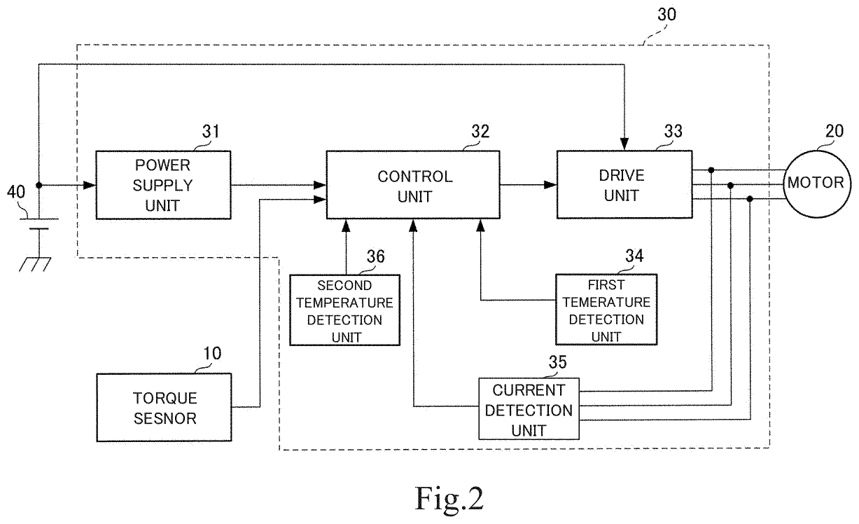

FIG. 2 is a block diagram showing a configuration of the motor drive apparatus 30. As shown in FIG. 2, the motor drive apparatus 30 is electrically connected to the torque sensor 10, the motor 20, and the external power supply 40. The motor drive apparatus 30 includes a control assembly that includes a power supply unit 31, a controller 32, a drive 33, a first temperature detector 34, a current detector 35, and a second temperature detector 36.

The power supply unit 31 supplies electric power from the external power supply 40 to the controller 32. The drive 33 is supplied with electric power from the external power supply 40 without going through the power supply unit 31.

The controller 32 receives a torque signal output from the torque sensor 10. As the controller 32, for example, a computer having an arithmetic processing unit such as a CPU, a memory such as a RAM, and a storage unit such as a hard disk drive is used. However, an electric circuit having an arithmetic device such as a microcontroller may be used instead of the computer. The controller 32 calculates the heat storage amount stored in the control assembly using the detection result by the first temperature detector 34, the detection result by the current detector 35, the detection result by the second temperature detector 36, and the like. A specific calculation method will be described later.

The drive 33 includes an inverter circuit and an inverter drive, and supplies an electric current to the motor 20. The inverter circuit includes, for example, a transistor such as a metal oxide semiconductor field effect transistor (MOSFET) as a switching element. In the present example embodiment, since a three-phase synchronous brushless motor is used as the motor 20, the inverter circuit is provided with three pairs of switching elements in parallel. Note that when the motor drive apparatus 30 is used as a multi-system drive system to drive one motor 20 or a plurality of motors 20, the drive 33 includes a plurality of inverter circuits.

The inverter drive is an electric circuit for operating the inverter circuit. In the present example embodiment, the inverter drive supplies a PWM drive signal of the pulse width modulation (PWM) system output from the controller 32 and instructing the drive amount of the motor 20, to the six switching elements included in the inverter circuit. The inverter circuit supplies electric current to each of the U phase, the V phase, and the W phase of the motor 20, on the basis of the PWM drive signal supplied from the inverter drive.

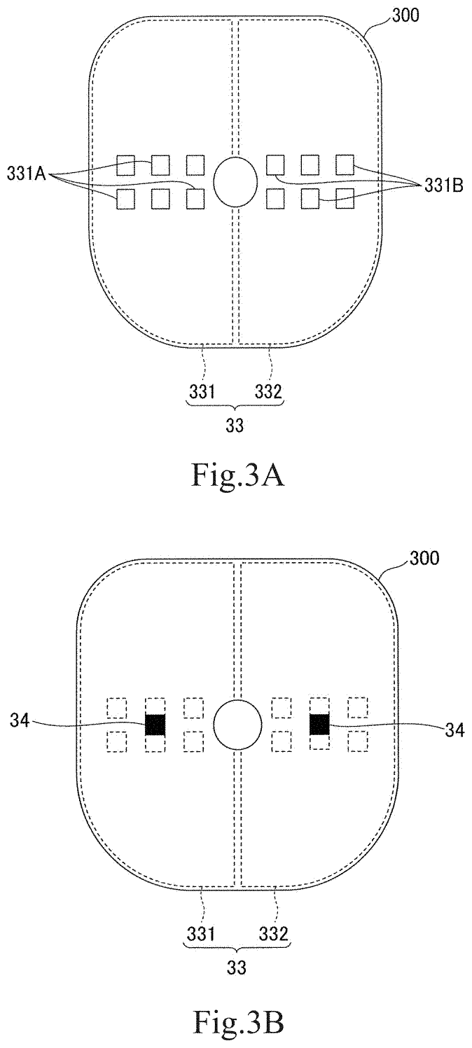

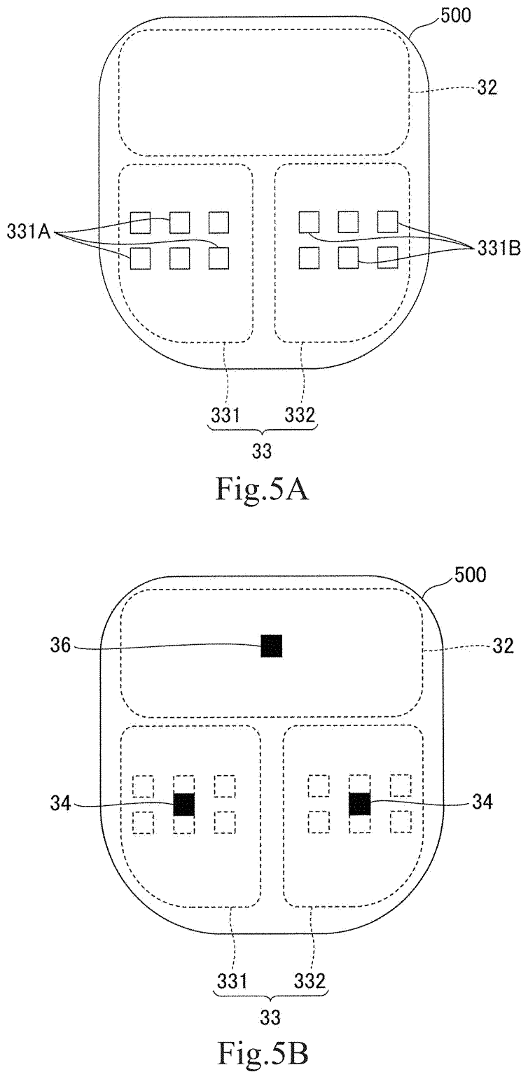

The first temperature detector 34 detects the temperature of the drive 33 and outputs the detected temperature to the controller 32. When the drive 33 includes a plurality of inverter circuits, the first temperature detector 34 is disposed for each of the inverter circuits. It is desirable that the first temperature detector 34 be disposed near a location where the heat generating components of the inverter circuit are concentrated, that is, near the center of the circuit, for example. The details will be described with reference to FIGS. 3A, 3B, 5A, and 5B. Here, the main heat-generating component is a metal oxide semiconductor field effect transistor (MOSFET) used as a switching element.

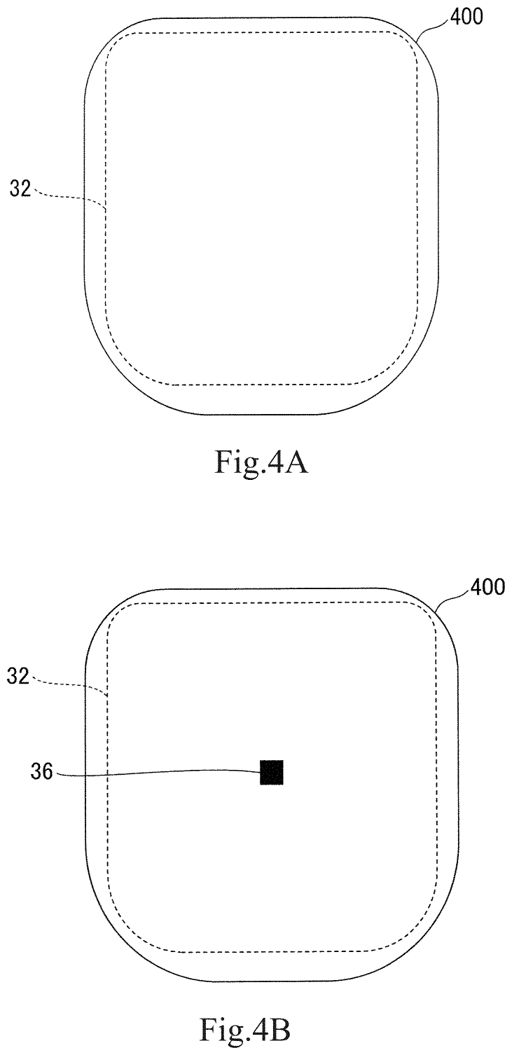

The second temperature detector 36 detects the temperature of the controller 32 and outputs the detected temperature to the controller 32. When the first temperature detector 34 is arranged for each of the inverter circuits, a single second temperature detector 36 is provided at a position equidistant from the respective first temperature detector 34. The details will be described with reference to FIGS. 4A, 4B, 5A, and 5B.

As each of the first temperature detector 34 and the second temperature detector 36, a thermistor whose resistance value varies depending on the detected temperature from the viewpoint of sensitivity, size, and the degree of freedom of resolution. Further, an angle sensor for detecting the rotational position of the rotor of the motor 20 may also serve as the second temperature detector 36. In this case, the motor drive apparatus 30 can be advantageous in terms of device cost and size.

The detected temperatures detected by the first temperature detector 34 and the second temperature detector 36 are used to estimate the heat release amount from the control assembly. By disposing the first temperature detector 34 for each of the inverter circuits and in the vicinity where the heat generating components are concentrated, the estimation accuracy of the heat release amount can be improved. Among the detected temperatures obtained for the respective inverter circuits, the highest temperature is used for estimating the heat release amount. Thereby, the control accuracy of overheat protection can be improved.

FIGS. 3A and 3B are diagrams showing the arrangement of the first temperature detectors 34 when the controller 32 and the drive 33 are formed on different substrates. Among the components of the control assembly, the main heat source is the drive 33. If the controller 32 and the drive 33 are formed on different substrates, heat may not easily accumulate in the control assembly.

FIG. 3A is a diagram showing a drive substrate 300 on which the elements constituting the drive 33 are arranged as viewed from the surface on which the elements are arranged, and FIG. 3B is diagram showing the drive substrate 300 as viewed from the opposite side of the surface on which the elements are arranged. Hereinafter, in FIGS. 3A, 3B, 4A, 4B, 5A and 5B, one surface on which the elements are disposed is called an element surface, and the other surface on which the temperature detectors are disposed is called a sensor surface.

In FIGS. 3A and 3B, switching elements (MOSFETs) included in the inverter circuits and the first temperature detectors 34 are illustrated for the sake of simplicity of explanation. The drive 33 includes a first inverter circuit 331 and a second inverter circuit 332. As shown in FIGS. 3A and 3B, the first inverter circuit 331 and the second inverter circuit 332 include six switching elements 331A and six switching elements 331B, respectively. As shown in FIG. 3B, the first temperature detector 34 is disposed on the sensor surface opposite to the center of the region where the plurality of MOSFETs are arranged, for each inverter circuit.

FIGS. 4A and 4B are diagrams showing an arrangement of the second temperature detector 36 when the controller 32 and the drive 33 are formed on different substrates. For simplification of explanation, only the second temperature detector 36 is shown. FIG. 4A is a diagram showing a controller substrate 400 as viewed from the element surface, and FIG. 4B is a diagram of the controller substrate 400 as viewed from the sensor surface.

The drive substrate 300 and the controller substrate 400 are configured with their element surfaces facing each other. The second temperature detector 36 is disposed at a position on the surface of the controller substrate 400 that is equidistant from the respective first temperature detectors 34 disposed on the drive substrate 300. By disposing the first temperature detectors 34 and the second temperature detector 36 in the positional relationship as described above, a difference in the heat release amounts calculated between the inverter circuits is less likely to occur, and the heat release amount can be calculated stably.

FIGS. 5A and 5B are diagrams showing the arrangement of the first temperature detectors when the controller and the drive are formed on one substrate. FIG. 5A is a diagram showing a substrate 500 on which the elements constituting the controller 32 and the drive 33 are disposed as viewed from the element surface, and FIG. 5B is a diagram showing the substrate 500 as viewed from the sensor surface. The drive 33 includes a first inverter circuit 331 and a second inverter circuit 332.

In FIGS. 5A and 5B, the switching elements 331A and the switching elements 331B, the first temperature detectors 34, and the second temperature detector 36 are illustrated for simplification of description. As shown in FIG. 5B, the first temperature detector 34 is arranged at the center of each inverter circuit and at the center of the region where the MOSFETs are disposed, and the second temperature detector 36 is disposed at a position equidistant from the respective first temperature detectors 34. By arranging them in such a positional relationship, a difference in the heat release amount calculated between the inverter circuits is less likely to occur, and the heat release amount can be calculated stably.

The current detector 35 detects the electric current flowing through the drive 33. In the present example embodiment, since a three-phase synchronous brushless motor is used as the motor 20, the electric current supplied to each of the U phase, V phase, and W phase of the motor 20 is detected. The current detector 35 outputs a current value of the detected electric current to the controller 32. When the drive 33 includes a plurality of inverter circuits, the current detector 35 detects a current for each of the inverter circuits.

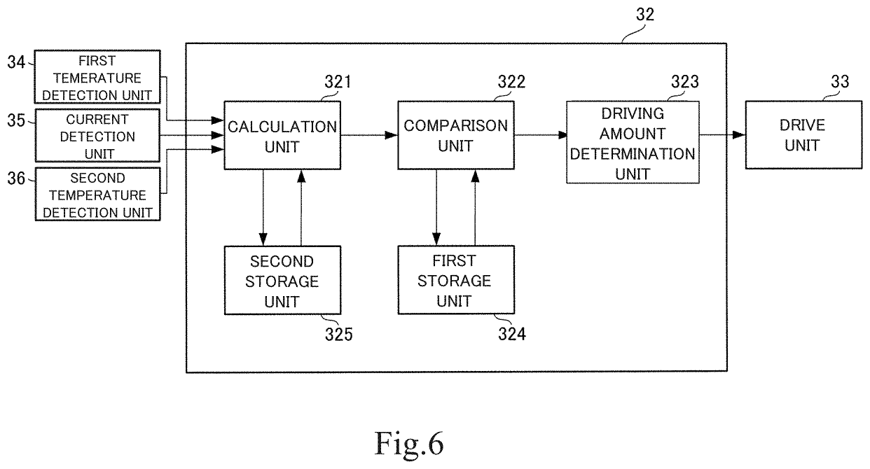

FIG. 6 is a block diagram showing the functions of the controller 32. The controller 32 includes a calculation unit 321, a comparison unit 322, a drive amount determination unit 323, a first storage unit 324, and a second storage unit 325.

The calculation unit 321 calculates the heat storage amount stored in the control assembly at a predetermined cycle. The predetermined cycle is determined on the basis of, for example, the accuracy required for overheat protection, and is set to 100 milliseconds in the present example embodiment. The heat storage amount Qₙ calculated at the n^{th} time by the calculation unit 321 is expressed by the following equation (1) where Q₀ represents a predetermined initial value, Q⁺ represents an estimated value of the heat generation amount of the motor at the time of calculation, and Q⁻ represents an estimated value of the heat release amount at the time of calculation. Q₀ is zero, for example. If a certain amount of heat storage is already assumed at the time before the calculation is started, a value other than zero can be set as the initial value.

$$\begin{matrix}[ Equation 1 ] & \\ {\sum }^{n} {Q}_{n} = {\sum }^{n - 1} {Q}_{n - 1} + {Q}^{+} - {Q}^{-} & ( 1 )\end{matrix}$$

The estimated value Q⁺ of the heat generation amount of the motor at the time of calculation is obtained by multiplying the square root of the q-axis component and the d-axis component of the current value detected by the current detector 35, the square root of the voltage value of the external power supply 40, and a predetermined period together, for example. The estimated value Q⁻ of the heat release amount at the time of calculation is obtained on the basis of a difference ΔT obtained by subtracting a predetermined temperature from the detected temperature detected by the first temperature detector 34.

The predetermined temperature is a detected temperature detected by the second temperature detector 36 or an ambient temperature of the control assembly measured in advance. Which one is set as the predetermined temperature may be determined depending on the amount of fluctuation of the ambient temperature. For example, when the amount of fluctuation in the ambient temperature is large such as the case where the motor drive apparatus 30 is used in an environment with a severe temperature difference, the estimation accuracy of the heat release amount may be improved if a measured value by the second temperature detector is set as the predetermined temperature. Further, as the predetermined temperature, the calculation unit 321 may set the detection temperature and the ambient temperature to be selectable, and when the second temperature detector 36 fails, for example, the ambient temperature may be selected as the predetermined temperature.

The comparison unit 322 compares the heat storage amount Qₙ obtained by the calculation unit 321 with a predetermined threshold, and determines whether or not the heat storage amount Qₙ is larger than the predetermined threshold. The comparison unit 322 outputs the determination result to the drive amount determination unit 323. The comparison unit 322 refers to the first association information stored in the first storage unit 324 and determines the predetermined threshold. The details will be described later.

The drive amount determination unit 323 determines the drive amount of the motor 20 on the basis of the determination result output from the comparison unit 322. In the case of a determination result that the heat storage amount Qₙ is larger than the predetermined threshold, the drive amount determination unit 323 determines, as a drive amount of the motor 20, a drive amount smaller than the drive amount of the motor 20 at the time of calculating the heat storage amount Qₙ, in order to prevent the control assembly from overheating. In the case of the determination result that the heat storage amount Qₙ is equal to or smaller than the predetermined threshold, the drive amount is not particularly limited.

The first storage unit 324 stores the first association information in which the number of inverter circuits that supply current to the motor 20 among the inverter circuits of the drive (hereinafter referred to as the number of driving inverter circuits) and a threshold of the heat storage amount are associated with each other.

In the first association information, the smaller the number of driving inverter circuits is, the greater the associated threshold is. Thus, it is possible to prevent excessive overheat protection that limits the current supplied to the motor 20 in a state where it is not necessary to prevent overheating. Further, the threshold of the heat storage amount decreases as the temperature of the drive 33 is higher. Thereby, the precision of overheat protection can be improved.

The calculation unit 321 calculates the number of drive inverter circuits on the basis of the detection result by the current detector 35, and outputs the calculated number of driving inverter circuits to the comparison unit 322. The comparison unit 322 refers to the first association information stored in the first storage unit 324, and obtains a threshold of the heat storage amount corresponding to the number of driving inverter circuits output from the calculation unit 321. The comparison unit 322 determines the obtained threshold to be a predetermined threshold to be compared with the heat storage amount Qₙ.

By storing the first association information in the first storage unit 324 in advance, it is not necessary to calculate a predetermined threshold each time the number of driving inverter circuits varies, and it is possible to perform overheat prevention control stably.

The second storage unit 325 stores second association information in which the difference ΔT obtained by subtracting a predetermined temperature from the temperature detected by the first temperature detector 34 is associated with the heat release amount.

In the second association information, when ΔT is negative, that is, when the temperature of the controller 32 or the ambient temperature is higher than the temperature of the drive 33, the heat release amount corresponding to ΔT is the lowest value (for example, zero). On the other hand, when ΔT is 0° C. or higher, the heat release amount corresponding to ΔT may vary depending on the magnitude of ΔT.

When ΔT is 0° C. or higher, the heat release amount corresponding to ΔT can be obtained as follows. The case of obtaining the heat release amount when ΔT=30° C. will be described as an example. First, the current supplied to the motor 20 is set to zero when ΔT=30° C. for the first time after the driving of the motor 20 is started. Thereafter, the time point at which ΔT=0° C. is measured. The measured time is set as to.

With use of the above equation (1), Q⁻ is calculated such that the time point at which the heat storage amount Qₙ becomes zero coincides with to. The calculated Q⁻ is the heat release amount corresponding to ΔT=30° C. The second association information can be obtained by performing the above calculation with a plurality of ΔT. The relationship between ΔT and the heat release amount is not only linear but may also be a logarithmic relationship.

As described above, the estimation accuracy can be improved by estimating the heat release amount in consideration of the time variation of the heat release amount. Further, since the heat storage amount can be calculated using the estimated value of the heat release amount with improved accuracy, the accuracy of the overheat protection control can be improved. Furthermore, it is possible to prevent components such as electronic components included in the control assembly from being damaged by the heat.

By storing the second association information in the second storage unit 325 in advance, it is not necessary to calculate the estimated value of the heat release amount each time ΔT is obtained, and it is possible to perform overheat prevention control stably.

Note that as a current detection value and a temperature detection value to be used for calculation of the heat storage amount Qₙ, not only the values at the time of calculation but also an average value, a median value, and the like of the values detected from the previous (n−1^{th}) time of calculation until the current (n^{th})) time of calculation may also be used.

As described above, according to the present example embodiment, it is possible to provide a motor drive apparatus that is advantageous in terms of reliability of control for preventing overheating of the control assembly. In addition, the electric power steering apparatus to which the motor drive apparatus of the present example embodiment is applied can be advantageous in terms of driving comfortability.

The motor 20 is not limited to that having three phases. Further, the motor drive apparatus 30 may be applied to devices other than the power steering system. For example, a motor used in other parts of a transportation apparatus such as an automobile may be driven by the motor drive apparatus 30 described above. Further, a motor mounted on an apparatus other than an automobile, such as an industrial robot, may be driven by the motor drive apparatus 30 described above.

While an example embodiment of the present disclosure has been described above, the present disclosure is not limited to such an example embodiment. Various modifications and change can be made within the scope of the spirit of the present disclosure.

The present application is based upon and claims the benefit of priority from Japanese Patent Application No. 2017-90199, filed on Apr. 28, 2017, the disclosure of which is incorporated herein in its entirety by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-15. (canceled)

16. A motor drive apparatus comprising a control assembly that controls driving of a motor, wherein
the control assembly includes:
a controller that outputs a drive signal instructing a drive amount of the motor;
a drive that supplies electric current, supplied from an external power supply, to the motor based on the drive signal output from the controller;
a current detector that detects an electric current flowing through the drive; and
a first temperature detector that detects a temperature of the drive;
wherein
the control assembly calculates a heat storage amount stored in the control assembly at a predetermined cycle, and when the calculated heat storage amount is larger than a predetermined threshold, the control assembly outputs the drive signal that instructs a drive amount smaller than the drive amount at a time of calculation; and
a heat storage amount Qₙ calculated at an n^{th} time, where n is an integer equal to or greater than 1, by the controller is a value that is obtained by, when Q₀ is a predetermined initial value, adding, to a heat storage amount Qₙ₋₁ calculated at an n−1^{th} time, an estimated value of a heat generation amount of the motor obtained based on a voltage of the external power supply, the predetermined cycle, and a current value of the electric current detected, and subtracting an estimated value of a heat release amount obtained based on a difference between the temperature detected by the first temperature detector and a predetermined temperature.

17. The motor drive apparatus according to claim 16, wherein the predetermined initial value is zero.

18. The motor drive apparatus according to claim 16, wherein the current value and the temperature to be used by the controller in calculating the heat storage amount are a current value of the electric current and the temperature detected at the time of calculation.

19. The motor drive apparatus according to claim 16, wherein the estimated value of the heat release amount when the temperature detected by the first temperature detector is lower than the predetermined temperature is smaller than the estimated value of the heat release amount at a time when the temperature detected by the first temperature detector is equal to or higher than the predetermined temperature.

20. The motor drive apparatus according to claim 16, wherein
the drive includes a plurality of inverter circuits; and
the first temperature detector is provided to each of the plurality of inverter circuits.

21. The motor drive apparatus according to claim 20, wherein a highest temperature among the temperatures detected by the first temperature detector is used to obtain the estimated value of the heat release amount.

22. The motor drive apparatus according to claim 20, wherein
the current detector detects each of electric currents flowing through each of the plurality of inverter circuits; and
the controller determines the predetermined threshold based on each of the electric currents detected by the current detector.

23. The motor drive apparatus according to claim 22, wherein
the controller obtains a number of the inverter circuits in which the electric currents are detected based on each of the electric currents detected by the current detector, and by referring to first association information in which the number and a threshold of the heat storage amount are associated with each other in advance, determines the threshold corresponding to the number as the predetermined threshold.

24. The motor drive apparatus according to claim 23, wherein the threshold associated in the first association information is smaller as the number becomes larger.

25. The motor drive apparatus according to claim 16, wherein the controller determines, as the estimated value, the heat release amount corresponding to the difference obtained at a time of calculating the heat storage amount with reference to second correlation information in which the difference and the heat release amount are associated with each other.

26. The motor drive apparatus according to claim 16, wherein
the control assembly includes a second temperature detector that detects a temperature of the controller; and
the second temperature detector is at a position equidistant from the first temperature detectors each of which is provided to each of the plurality of inverter circuits in the drive.

27. The motor drive apparatus according to claim 26, wherein the predetermined temperature is the temperature detected by the second temperature detector.

28. The motor drive apparatus according to claim 26, wherein the first temperature detector or the second temperature detector that detects the temperature of the controller includes a thermistor in which a resistance value varies according to the temperature detected.

29. The motor drive apparatus according to claim 16, wherein a substrate on which the controller is provided and a substrate on which the drive is provided are different from each other.

30. An electric power steering apparatus comprising a motor to be driven by the motor drive apparatus according to claim 16.
